(19) United States
(12) Patent Application Publication
(10) Pub. No.: US 2003/0099497 A1
(43) Pub. Date: May 29, 2003

(54) Keyboard with adjustable key rows

(76) Inventor: Xinbo Zhang, New Haven, CT (US)

Correspondence Address: XINBO ZHANG, Apt. # 4, 392 Whitney Avenue, New Haven, CT, 06511, US

(21) Appl. No.: 09/992,045

(22) Filed: Nov. 16, 2001

(51) Int. Cl. B41J 5/12

(52) U.S. Cl. 400/472

(57) ABSTRACT

A keyboard with adjustable key rows comprises a plurality of keys arranged as left-hand and right-hand parallel key rows, including three left-hand alphabetic key rows and three right-hand alphabetic key rows. At least two said key rows are adjustable key rows that are mounted on individual sliding bases and can be shifted in their supporting slots for continuously adjusting the key row positions for typing operation. Locking means, adjusting means and linking means are presented for facilitating the adjustments of said adjustable key rows. The operator of said keyboard can reorganize the key arrangement of said keyboard flexibly and ergonomically according to the operator's typing preferences to increase comfort and typing speed.

### CROSS-REFERENCE TO RELATED APPLICATIONS

CROSS-REFERENCE TO RELATED APPLICATIONS
U.S. Patent Documents

| | | | |
|---|---|---|---|
| 4613247 | Sep., 1986 | McGunnigle | 400/486. |
| 4971465 | Nov., 1990 | Hashimoto | 400/485. |
| 5141343 | Aug., 1992 | Roylance, et al. | 400/472. |
| D357476 | Apr., 1995 | Paull, et al. | D14/393. |
| 5612691 | Mar., 1997 | Murmann, et al. | 341/22. |
| 5703578 | Dec., 1997 | Allison | 341/22. |
| 5774384 | Jun., 1998 | Okaya, et al. | 345/169. |
| 5788386 | Aug., 1998 | Hayahsi | 341/22. |
| 5951178 | Sep., 1999 | Lim | 400/472. |
| 5995025 | Nov., 1999 | Sternglass, et al. | 341/22. |
| 6005496 | Dec., 1999 | Hargreaves, et al. | 341/22. |
| 6022156 | Feb., 2000 | Blish | 400/472. |
| 6042282 | Mar., 2000 | Camacho, et al. | 400/486. |
| 6068417 | May., 2000 | Butler | 400/492. |
| 6056456 | May., 2000 | Kinoshita | 400/472. |
| 6111527 | Aug., 2000 | Susel | 341/22. |
| 6174097 | Jan., 2001 | Daniel | 400/472. |

### BACKGROUND OF THE INVENTION

The present invention relates to a keyboard for computers, electronic typewriters and similar control devices for use by an operator, more particularly to a keyboard with adjustable key rows.

A conventional keyboard usually has a plurality of keys mounted on the fixed keyboard surface with the key arrangement of the standard QWERTY format. The left-hand keys are placed backwards against the operator's natural typing positions. During typing operation, the operator's wrists are bent towards each other and the fingers are turned at different angles to move in different directions. The operator's shoulders, wrists and fingers may fatigue quickly and become painful. Some typing injuries may also occur, such as repetitive stress disorder and carpal tunnel syndrome.

A lot of efforts have been made to address the above issues by redesigning a conventional keyboard ergonomically either by changing the keyboard construction or changing the key arrangement. Some examples are U.S. Pat. Nos. D357476, 5,612,691, 5,788,386, 6,005,496, 6,022,156, 6,042,282 & 4,613,247. The keyboards of these patents are designed ergonomically by separating the keyboard into left and right portions, separating the keys into left and right sections or even completely rearranging the traditional positions of the alphabetic keys. But the keys of all these prior art keyboards are mounted permanently on the keyboard surfaces. The relative key positions of each hand can not be changed further for typing operation. So the key arrangements of the keyboards can not be adjusted according to the operator's typing preferences.

Some patented keyboard designs utilize the adjustable structures for the purposes of portability or space savings, such as a folding or collapsible keyboard for travel use and an expandable or compressible keyboard for portable computers. Some examples are U.S. Pat. Nos. 5,703,578, 6,174,097, 5,995,025, 5,951,178, 6,068,417, 6,056,456 & 6,111,527. These patented keyboard designs still use the traditional key arrangement of a conventional keyboard and usually have two modes, one fully operating mode and one space saving mode. These keyboard designs did not address the mentioned key arrangement issues of a conventional keyboard.

### BRIEF SUMMARY OF THE INVENTION

The present invention provides a two-hand keyboard with adjustable key rows. It addresses the mentioned key arrangement issues of a conventional keyboard by making the key rows adjustable in order to change the key arrangement of the keyboard ergonomically for typing operation. The invention keyboard provides more comfort and more flexibility to the operator of said keyboard. The key arrangement of said keyboard can be reorganized flexibly according to the operator's typing preferences.

The invention keyboard comprises a plurality of left-hand parallel key rows and right-hand parallel key rows, including three alphabetic key rows for each hand. Two or more said key rows are adjustable key rows that are mounted on individual sliding bases and can be shifted in their own supporting slots for continuously adjusting the key row positions of said keyboard for typing operation. The operator of said keyboard can have different key arrangements to satisfy the operator's own needs.

One embodiment of the invention keyboard includes an alphabetic key section that comprises both left-hand and right-hand parallel key rows. The correspondent key rows of both hands are aligned together on the same row. Said alphabetic key section comprises three adjustable key rows for each hand and three supporting slots shared by both left-hand and right-hand adjustable key rows. Each said adjustable key row comprises one alphabetic key row of one hand. So the operator of said keyboard can change the key arrangements of the keyboard for both hands.

Another embodiment of the invention keyboard also includes one alphabetic key section that comprises both left-hand and right-hand parallel key rows. The correspondent key rows of both hands are aligned together on the same row. Said alphabetic key section includes three left-hand adjustable key rows and their supporting slots. Each said adjustable key row comprises one left-hand alphabetic key row. So the operator of said keyboard can adjust the left-hand key positions for solving the mentioned issues of the left-hand key arrangement of a conventional keyboard.

In both above embodiments, the key arrangement of the invention keyboard can be compatible with the standard QWERTY keyboard format by properly adjusting all said adjustable key rows to certain positions. The beginning users of said keyboard can also remember the alphabetic key positions easily by separating the keys of both hands and aligning the keys better as columns. The key arrangement of said keyboard can also be adjusted ergonomically to accommodate the natural orientations and movements of the operator's wrists, hands and fingers by shifting the lower left-hand adjustable key rows further to the left one by one.

The third embodiment of the invention keyboard comprises one left alphabetic key section and one right alphabetic key section. The left alphabetic key section comprises left-hand parallel key rows and the right alphabetic key section comprises right-hand parallel key rows. Each said alphabetic key section comprises three adjustable key rows and each said adjustable key row comprises one alphabetic key row. The longitudes of two said key sections make an inner angle of 120 to 180 degrees, α. The adjacent edges of two said key sections are parallel to each other. This embodiment of the invention keyboard further accommodates the orientations of the operator's hands and wrists and provides more comfort to the operator besides adjusting the adjustable key rows.

The lower supporting slots of the invention keyboard are equal or longer than the upper supporting slots of the same hand. The lower adjustable key rows of said keyboard can be shifted in an equal or longer range than the upper adjustable key rows of the same hand. Each said adjustable key row can be shifted in a range of about 1 to 3 key length. Each said adjustable key row can be adjusted individually in its supporting slot in one embodiment of said keyboard. All said adjustable key rows of one hand are linked together and can be shifted cooperatively in another embodiment of said keyboard.

Several means are also presented for facilitating said adjustable key rows of the invention keyboard for the position adjustments, including: a) locking means for maintaining the positions of said adjustable key rows; b) adjusting means for shifting said adjustable key rows in their supporting slots; and c) linking means for linking all said adjustable key rows of one hand pivotally together and shifting them cooperatively in their supporting slots. The invention keyboard can include more key functions by adding other key sections of a conventional keyboard, such as a function key section, an edit control key section and a numerical keypad section.

The invention keyboard provides more relaxation to the operator. It gives the operator more freedom of adjusting the key arrangement of the keyboard. It may also increase the operator's typing speed and efficiency.

### BRIEF DESCRIPTION OF THE DRAWINGS

FIG. 1 is a top plan view of the invention keyboard comprising a single alphabetic key section and the adjustable key rows of both hands in one embodiment.

FIG. 2 is a top plan view of the invention keyboard comprising a single alphabetic key section and the left-hand adjustable key rows in one embodiment.

FIG. 3 is a top plan view of the invention keyboard comprising two alphabetic key sections and the adjustable key rows of both hands in one embodiment.

FIG. 4 shows the key arrangement of the invention keyboard of FIG. 1 adjusted into the standard QWERTY keyboard format.

FIG. 5 shows the key arrangement of the invention keyboard of FIG. 2 adjusted into the standard QWERTY keyboard format.

FIG. 6 shows the key arrangement of the invention keyboard of FIG. 1 adjusted ergonomically to accommodate the natural orientations of the operator's hands and wrists.

FIG. 7 shows the key arrangement of the invention keyboard of FIG. 1 adjusted into better aligned key columns.

FIG. 8 is a top plan view of the invention keyboard of FIG. 1 comprising one kind of locking means.

FIG. 9 is the sectional view of the invention keyboard taken at the line I-I of FIG. 8.

FIG. 10 is a top plan view of the invention keyboard of FIG. 2 comprising another kind of locking means.

FIG. 11 is the sectional view of the invention keyboard taken at the line I-II of FIG. 10 while the locking means locks the adjustable key rows.

FIG. 12 is the sectional view of the invention keyboard taken at the line II-II of FIG. 10 while the locking means releases the adjustable key rows.

FIG. 13 is a top plan view of the invention keyboard of FIG. 1 comprising both left and right adjusting means.

FIG. 14 is the sectional view of the invention keyboard taken at the line III-III of FIG. 13.

FIG. 15 is a top plan view of the invention keyboard of FIG. 2 comprising left adjusting means.

FIG. 16 is a top plan view of the invention keyboard of FIG. 1 comprising both left and right linking means.

FIG. 17 is a top plan view of the invention keyboard of FIG. 2 comprising a left linking means.

FIG. 18 is the sectional plan view of the invention keyboard taken at the line IV-IV of FIG. 17.

### DETAILED DESCRIPTION OF THE INVENTION

The present invention focuses on a two-hand keyboard which comprises three parallel alphabetic key rows for each hand. By making certain key rows adjustable continuously for typing operation, the key arrangement of the keyboard can be reorganized flexibly and ergonomically. One embodiment of the invention keyboard comprises both left-hand and right-hand adjustable key rows. Another embodiment of the invention keyboard comprises left-hand adjustable key rows alone. Each said adjustable key row comprises one alphabetic key row of one hand mounted on a sliding base and can be shifted in its supporting slot continuously. The numeric key row and the auxiliary key row of each hand can also be made as individual adjustable key rows or combined with their adjacent alphabetic key rows to make one adjustable key row.

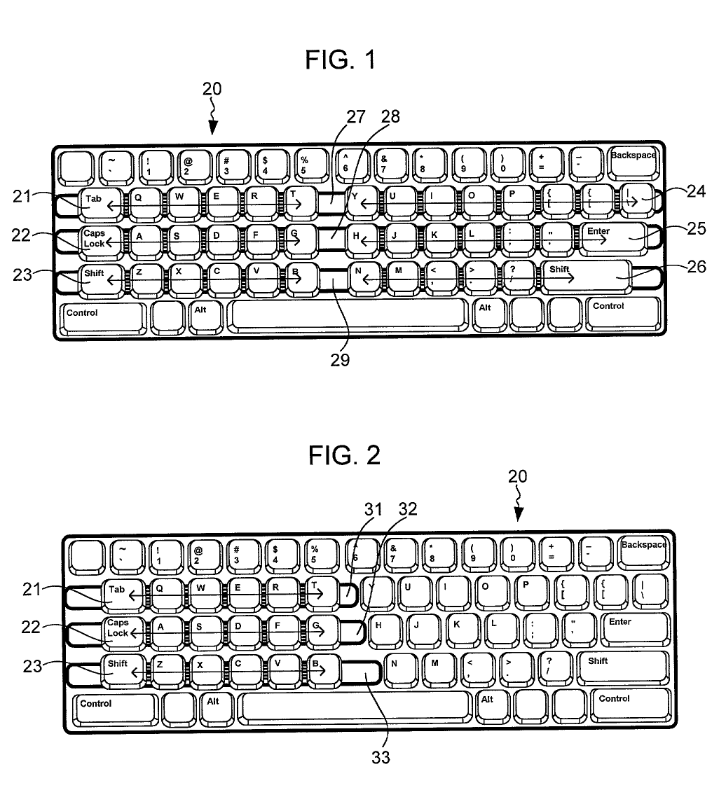

As illustrated in FIG. 1, one embodiment of the invention keyboard includes a rectangular alphabetic key section 20 that comprises both left-hand and right-hand parallel key rows. The correspondent rows of both hands are aligned together on the same row. The alphabetic key section 20 comprises three left-hand adjustable key rows 21, 22, 23, three right-hand adjustable key rows 24, 25, 26 and three supporting slots 27, 28, 29. The supporting slots 27, 28, 29 are shared by the adjustable key rows 21 & 24, 22 & 25, 23 & 26 respectively. Each said adjustable key row comprises one left-hand or right-hand alphabetic key row. The operator of said keyboard can adjust the key row positions of both hands to get a better key arrangement for typing operation.

As shown in FIG. 2, another embodiment of the invention keyboard also includes a rectangular alphabetic key section 20 that comprises both left-hand and right-hand parallel key rows. The correspondent rows of both hands are aligned together on the same row. The alphabetic key section 20 comprises three left-hand adjustable key rows 21, 22, 23 and their supporting slots 31, 32, 33. Each said adjustable key row comprises one left-hand alphabetic key row. The operator of the keyboard can adjust the left-hand key positions to solve the mentioned issues of the left-hand key arrangement of a conventional keyboard.

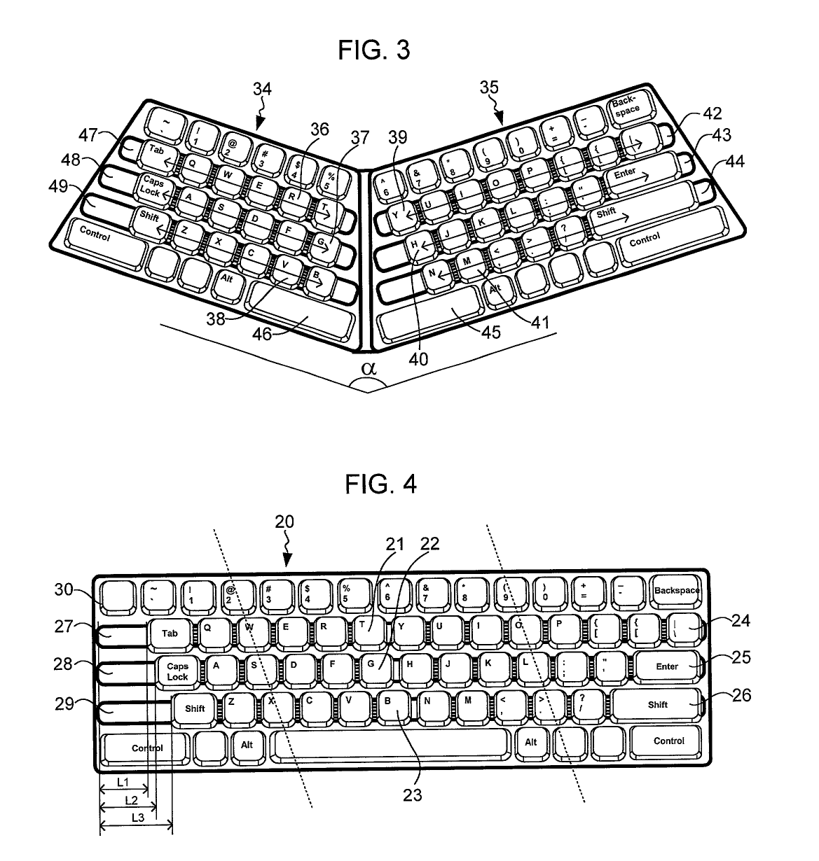

FIG. 3 illustrates the third embodiment of the invention keyboard that includes two trapezoidal alphabetic key sections, a left key section 34 and a right key section 35. The left key section 34 comprises three left-hand adjustable key rows 36, 37, 38, their supporting slots 47, 48, 49 and a space bar 46. The right key section 35 comprises three right-hand adjustable key rows 39, 40, 41, their supporting slots 42, 43, 44 and another space bar 45. Each said adjustable key row comprises one lefthand or right-hand alphabetic key row. The longitudes of two said key sections 34, 35 make an inner angle of 120 to 180 degree, a. The adjacent edges of two said key sections 34, 35 are parallel to each other. This embodiment of the invention keyboard further accommodates the orientations of the operator's hands and wrists and provides more comfort to the operator besides adjusting the adjustable key rows. Two said key sections 34, 35 can also be separated into two keyboard portions and connected pivotally in a different embodiment. The angle a can also be designed to be 180 degree in another embodiment so that the longitudes of two said key sections are parallel to each other.

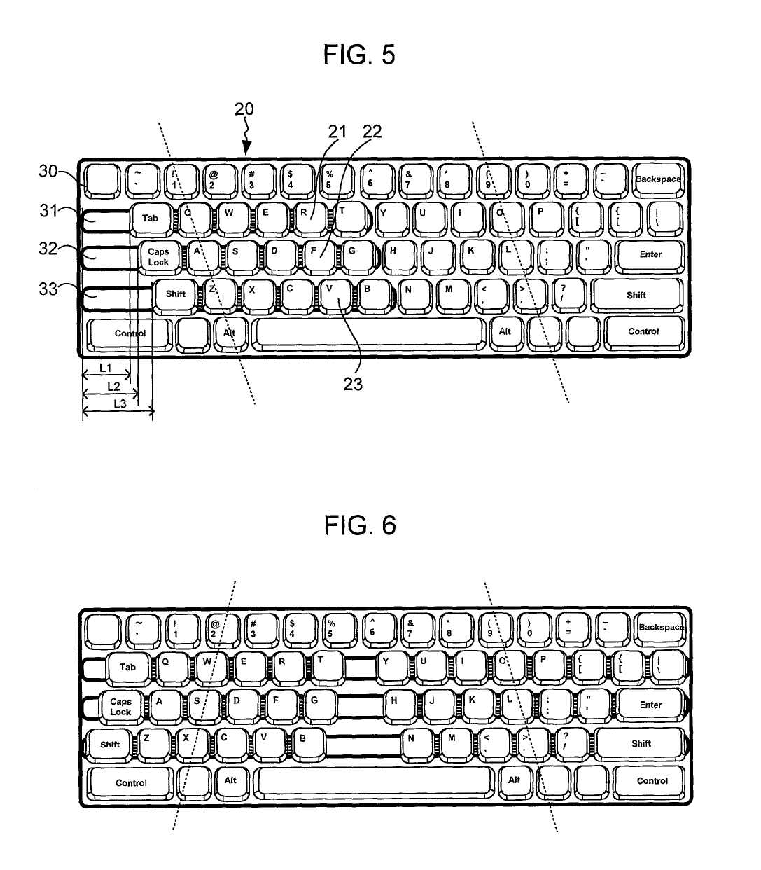

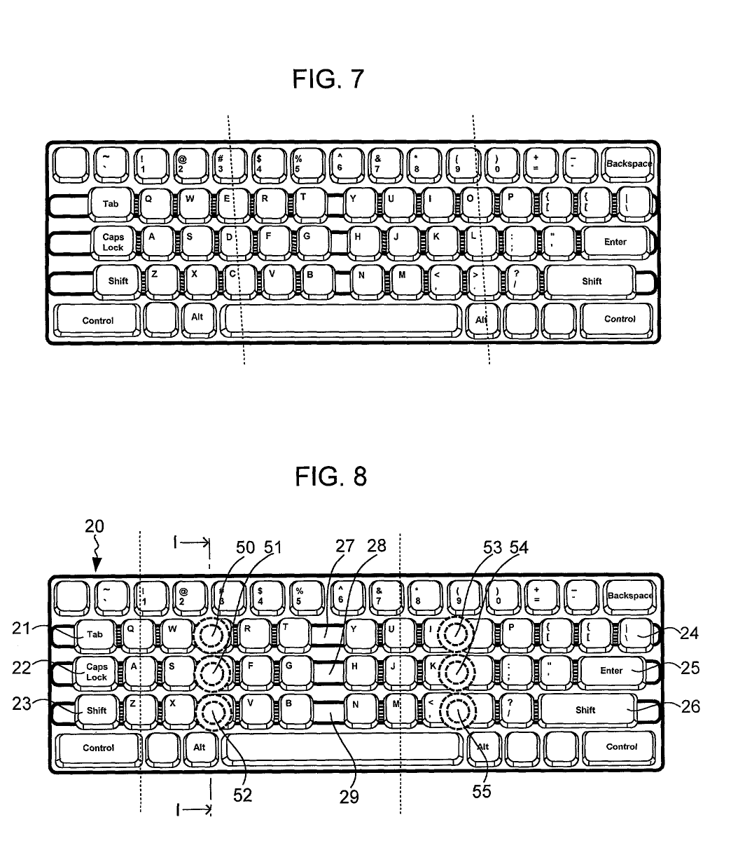

By referring FIGS. 4 & 5, the key arrangement of the invention keyboard of FIG. 1 or 2 can be compatible with the standard QWERTY keyboard format by properly adjusting all the adjustable key rows to certain positions. The shifting ranges L1, L2, L3 of said adjustable key rows 21 to 26 are about the length of 1 to 3 keys. The extra key 30 is used to fill in the empty space of the left upper corner. As illustrated in FIG. 6, the key arrangement of the invention keyboard can be adjusted ergonomically to accommodate the natural orientations and movements of the operator's wrists, hands and fingers by shifting the lower left-hand adjustable key rows further to the left one by one. By separating the keys of both hands and aligning the alphabetic keys as better columns shown in FIG. 7, beginning keyboard users can remember the relative positions of the alphabetic keys easily, and the reaching distances of the operator's fingers can also be decreased for a smaller hand. The long dotted lines in FIGS. 4 to 7 show the orientations of the alphabetic key columns of the key arrangements.

Several means are also presented for facilitating said adjustable key rows of the invention keyboard, including: a) locking means for maintaining the positions of said adjustable key rows; b) adjusting means for shifting said adjustable key rows in their supporting slots; and c) linking means for linking all said adjustable key rows of one hand pivotally together and shifting them cooperatively in their supporting slots. More different embodiments of the invention keyboard may include the combinations of said locking means, said adjusting means and said linking means, even though each kind of said means can be used in one embodiment of the invention keyboard independently.

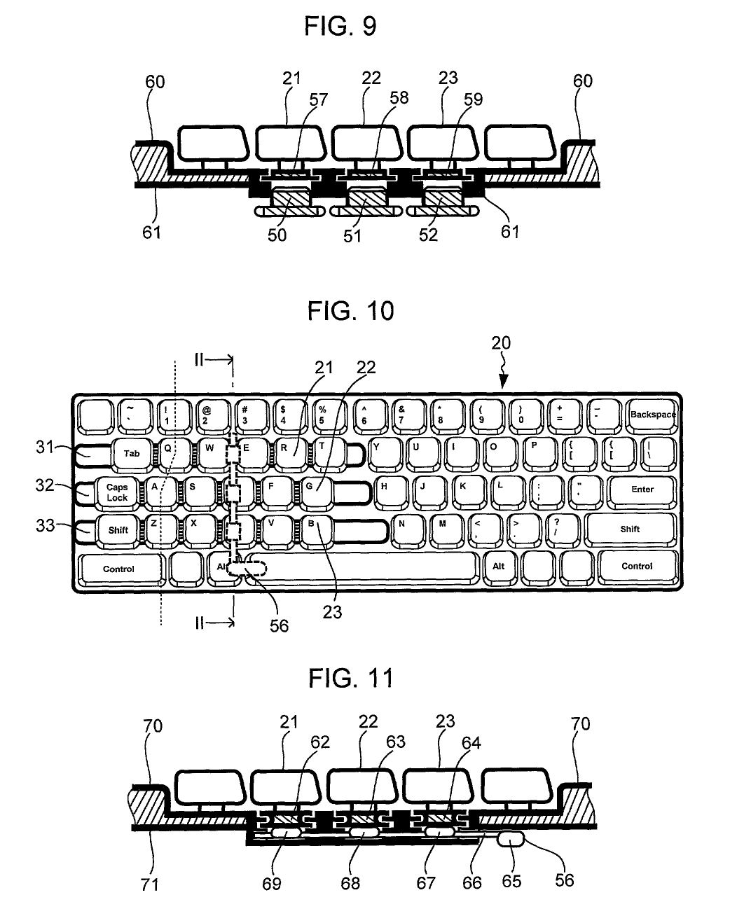

As shown in FIG. 8, the invention keyboard of FIG. 1 comprises three left locking means 50, 51, 52 and three right locking means 53, 54, 55. Each said adjustable key row can be shifted individually in its own supporting slot. FIG. 9 illustrates the sectional view of the invention keyboard taken at the line I-I of FIG. 8. The top frame 60 of the keyboard comprises three supporting slots that have notches to mount the sliding bases 57, 58, 59 of the adjustable key rows 21, 22, 23. Each said locking means comprises a lock screw mounted on the bottom frame 61 of the keyboard to fasten its adjustable key row.

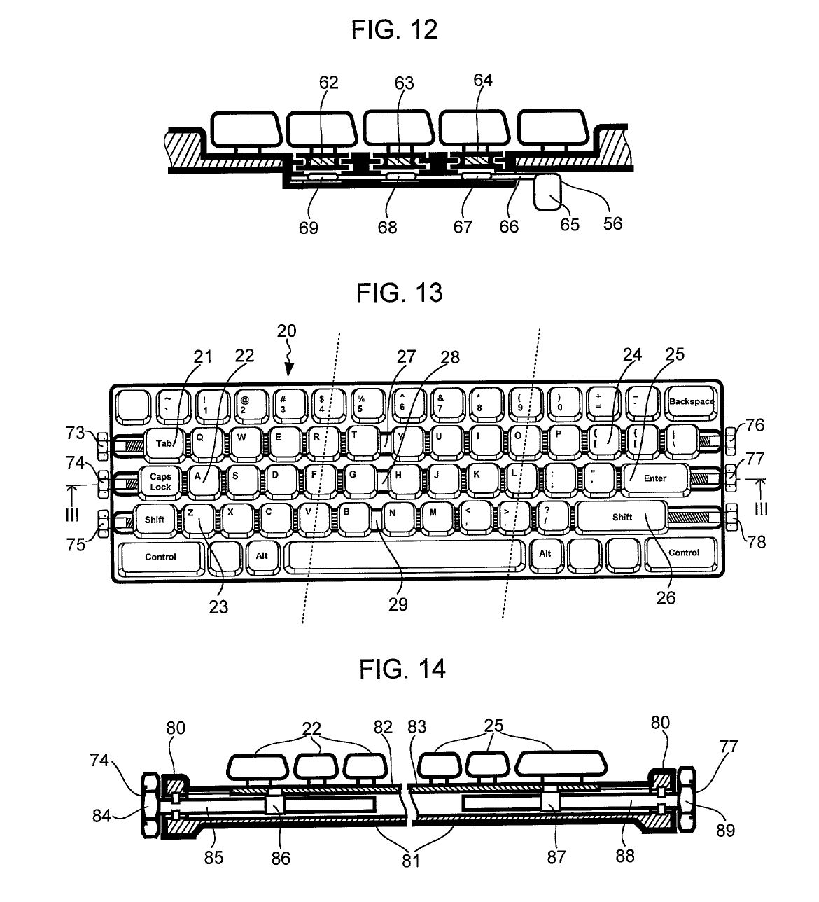

As illustrated in FIG. 10, the invention keyboard of FIG. 2 comprises one different locking means 56 that locks all the adjustable key rows 21, 22, 23 at the same time. Each said adjustable key row can be shifted individually in its own supporting slot. FIGS. 11 & 12 show the sectional views of the invention keyboard taken at the line II-II of FIG. 10. The top frame 70 of the keyboard comprises three slots supporting three sliding bases 62, 63, 64 that have notches on both edges of each said sliding base. The locking means 56 is mounted on the bottom frame 71 of the keyboard and comprises a handle 65 and a lock bar 66. The lock bar 66 further comprises three locking blades 67, 68, 69 that lock the sliding bases 64, 63, 62 respectively when the handle 65 is turned at the horizontal position as shown in FIG. 11. When the handle 65 is turned at the vertical position as shown in FIG. 12, the locking blades 67, 68, 69 go flat for unlocking the siding bases 64, 63, 62.

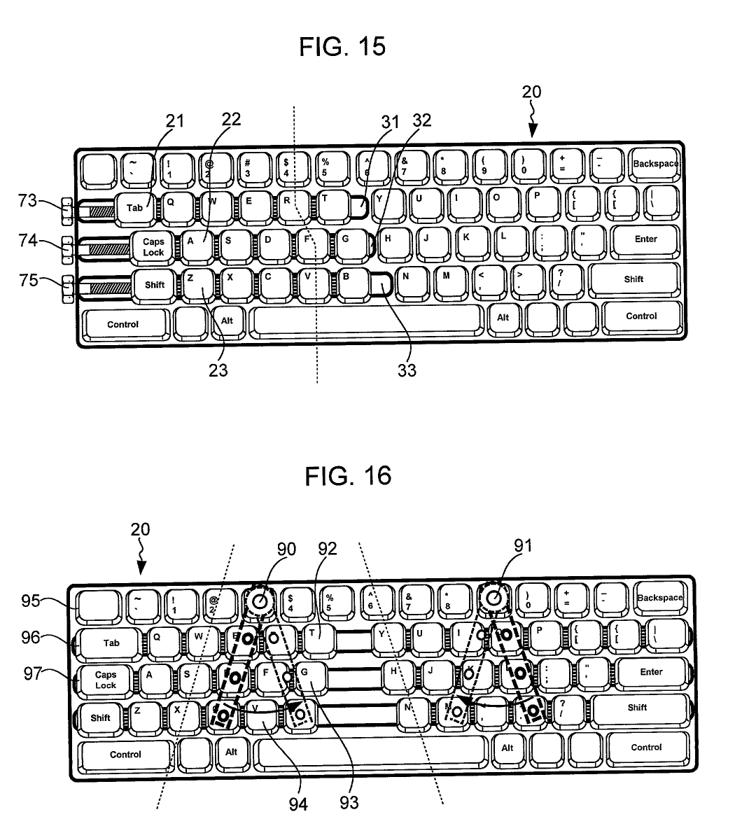

As shown in FIG. 13, the invention keyboard of FIG. 1 comprises three left adjusting means 73, 74, 75 and three right adjusting means 76, 77, 78. Each said adjustable key row can be shifted in its supporting slots individually by using its adjusting means. FIG. 14 illustrates the sectional view of the invention keyboard taken at the line III-III of FIG. 13. The keys of two adjustable key rows 22, 25 are mounted on their bases 82, 83. Two adjusting means 74, 77 are placed between the top frame 80 and the bottom frame 81 of the keyboard. The adjusting means 74 comprises a turning wheel 84, an adjusting bolt 85 and a nut 86. The nut 86 is mounted on the sliding base 82 of the adjustable key row 22. The adjusting means 77 comprises a turning wheel 89, an adjusting bolt 88 and a nut 87. The nut 87 is mounted on the sliding base 83 of the adjustable key row 25. So the adjusting bolts 85, 88 can shift their adjustable key rows 22, 25 by turning the wheels 84, 89. FIG. 15 illustrates the invention keyboard of FIG. 2 comprising three left adjusting means 73, 74, 75.

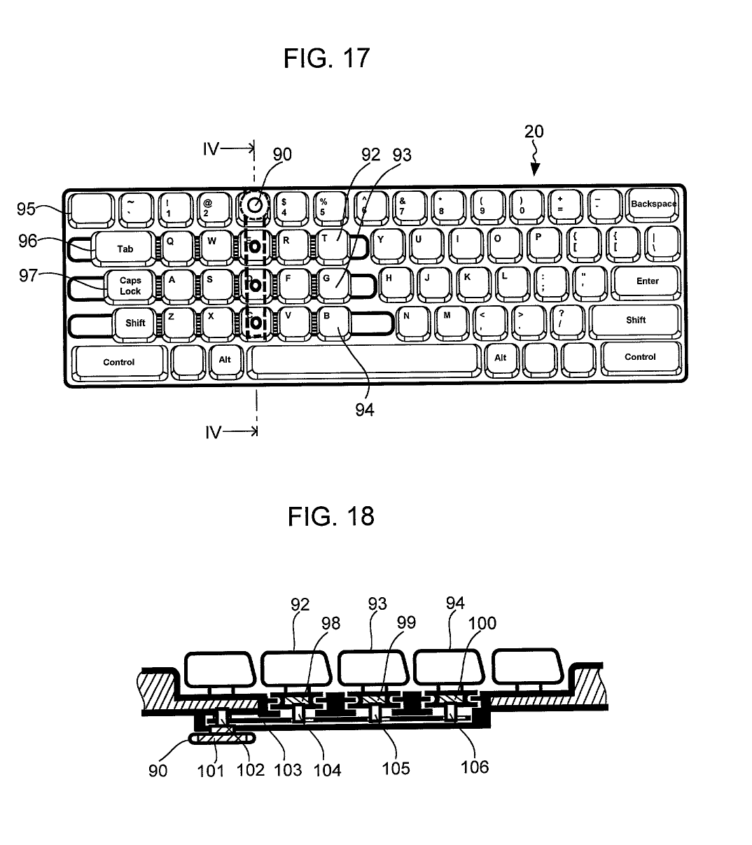

As illustrated in FIGS. 16 & 17, the invention keyboard of FIG. 1 comprises one left linking means 90 and one right linking means 91, and the invention keyboard of FIG. 2 comprises one left linking means 90. Three enlarged keys 95, 96, 97 are used to fill in the empty space of the left end of the key section 20. All the adjustable key rows of one hand can be shifted in their supporting slots cooperatively. FIG. 18 shows the sectional view of the keyboard taken at the line IV-IV of FIG. 17. The linking means 90 comprises a linking bar 103, its pivot 102, three fasteners 104, 105, 106 and a lock screw 101. The pivot 102 is mounted near the top row of the keyboard. The linking bar 103 links the adjustable key rows 92, 93, 94 pivotally through the fasteners 104, 105, 106. The fasteners 104, 105, 106 are mounted on the sliding bases 98, 99, 100 and can be moved slightly inside the link bar 103. The linking bar 103 can be turned around its pivot 102 to shift all said adjustable key rows 92, 93, 94 cooperatively. The lock screw 101 is used to lock the linking bar 103 so as to the adjustable key rows 92, 93, 94.

By referring to FIGS. 1 to 8, 10, 13, 14, 16 & 17, the lower supporting slots of the invention keyboard are equal or longer than the upper supporting slots of the same hand. So the lower adjustable key rows of said keyboard can be shifted in an equal or longer range than the upper adjustable key rows of the same hand. The shifting range of each said adjustable key row is about the length of 1 to 3 keys.

Several different key arrangements of the invention keyboard are also illustrated in FIGS. 8, 10, 13, 14 & 16 by adjusting said adjustable key rows to certain positions. The long dotted lines show the orientations of the alphabetic key columns of the key arrangements. FIG. 8 illustrates the key arrangement of the orthogonal key arrays by aligning the alphabetic keys as straight columns. FIG. 10 shows the key arrangement of the keyboard by aligning straight the first and second key rows, then the third and fourth key rows. The third and fourth rows are shifted together further to the left. FIG. 13 illustrates the backward key arrangement of the keyboard comparing to the key arrangement of a conventional keyboard. FIG. 14 shows the key arrangement of the keyboard by aligning straight the first and second key rows, then the third and fourth key rows. The third and fourth key rows are shifted together further to the right. FIG. 16 shows another ergonomic key arrangement of the keyboard accommodating the natural orientations and movements of the operator's wrists, hands and fingers.

The invention keyboard provides the operator more comfort and more flexibility by adjusting said adjustable key rows according to the operator's typing preferences. The invention keyboard can include more key functions by adding other key sections of a conventional keyboard, such as a function key section, an edit control key section and a numerical keypad section. More different embodiments can be constructed without departing the spirit and the scope of the invention as claimed.

What I claim as my invention:

1. A keyboard for computers, electronic typewriters and similar control devices for use by an operator, comprising: a plurality of keys arranged as left-hand parallel key rows and right-hand parallel key rows, including three left-hand alphabetic key rows and three right-hand alphabetic key rows; at least two adjustable key rows, each said adjustable key row including one or two said left-hand or right-hand parallel key rows mounted on one sliding base; and supporting slots supporting the sliding bases of said adjustable key rows to shift in said supporting slots for continuous adjustments of the key row positions; wherein the operator of said keyboard can reorganize the key arrangement of said keyboard for typing operation by adjusting the positions of said adjustable key rows.

2. A keyboard of claim 1, wherein said keyboard comprises one alphabetic key section in one embodiment, said alphabetic key section including both said left-hand and right-hand parallel key rows, the correspondent key rows of both hands being aligned together on the same row.

3. A keyboard of claim 2, wherein said alphabetic key section comprises both said left-hand and right-hand adjustable key rows.

4. A keyboard of claim 3, wherein said alphabetic key section comprises three said left-hand adjustable key rows, three said right-hand adjustable key rows and three shared supporting slots, each said adjustable key row comprising one alphabetic key row of one hand, each said shared supporting slot supporting the sliding bases of one left-hand adjustable key row and one right-hand adjustable key row.

5. A keyboard of claim 2, wherein said alphabetic key section comprises said left-hand adjustable key rows and their supporting slots.

6. A keyboard of claim 5, wherein said alphabetic key section comprises three said left-hand adjustable key rows, each said left-hand adjustable key row comprising one left-hand alphabetic key row.

7. A keyboard of claim 2, wherein the key arrangement of said keyboard can be adjusted to be compatible with the standard QWERTY key format by changing the positions of said adjustable key rows.

8. A keyboard of claim 1, wherein said keyboard comprises one left alphabetic key section and one right alphabetic key section in one embodiment, said left alphabetic key section comprising said left-hand parallel key rows, said right alphabetic key section comprising said right-hand parallel key rows.

9. A keyboard of claim 8, wherein the longitudes of two said key sections make an inner angle of 120 to 180 degrees, α.

10. A keyboard of claim 8, wherein the longitudes of two said key sections are parallel to each other.

11. A keyboard of claim 8, wherein each said alphabetic key section comprises three said adjustable key rows and their supporting slots, each said adjustable key row comprising one alphabetic key row of said key section.

12. A keyboard of claim 1, wherein each said adjustable key row can be shifted individually in its supporting slot in one embodiment.

13. A keyboard of claim 1, wherein all said adjustable key rows of one hand are linked together and can be shifted in their supporting slots cooperatively in one embodiment.

14. A keyboard of claim 1, wherein each said adjustable key row can be shifted in its supporting slot within the range of 1 to 3 key length.

15. A keyboard of claim 1, wherein said supporting slots for the lower adjustable key rows are equal or longer than said supporting slots for the upper adjustable key rows of the same hand.

16. A keyboard of claim 1, wherein the lower said adjustable key rows can be shifted in an equal or longer range than the upper said adjustable key rows of the same hand.

17. A keyboard of claim 1 comprising locking means for maintaining the positions of said adjustable key rows.

18. A keyboard of claim 1 comprising adjusting means for shifting said adjustable key rows in their supporting slots.

19. A keyboard of claim 1 comprising linking means for linking all said adjustable key rows of one hand together pivotally and shifting them cooperatively in their supporting slots.

20. A keyboard of claim 1 further comprising a function key section, an edit control key section and a numerical keypad section.
